(19) United States
(12) Patent Application Publication
(10) Pub. No.: US 2017/0070184 A1
(43) Pub. Date: Mar. 9, 2017

(54) TRANSPARENT, PHOTOVOLTAIC, THERMALLY INSULATING, CONSTRUCTION WALL COMPRISING CORRUGATED MATERIAL, AND BUILDINGS CONSTRUCTED THEREFROM

(71) Applicant: Alfred ISELI, Uttwil (CH)

(72) Inventor: Alfred ISELI, Uttwil (CH)

(21) Appl. No.: 15/121,778

(22) PCT Filed: Feb. 26, 2015
(86) PCT No.: PCT/IB2015/000248

§ 371 Date: Aug. 26, 2016

Related U.S. Application Data
(60) Provisional application No. 61/944,584, filed on Feb. 26, 2014.

(51) Int. Cl. H02S 20/26; E04B 1/76; E04F 13/00; H02S 40/42

(52) U.S. Cl. CPC H02S 20/26; H02S 40/425; E04B 1/7612; E04B 1/7675; E04F 13/007; E04B 1/80

(57) ABSTRACT

A photovoltaic construction wall is provided, having an inner surface adapted to face an inner enclosed space, and an outer surface adapted to gather energy from the sun when installed. The wall is used in buildings and also in buildings in building complexes. The construction wall includes a multi-layered composite wall comprising plates made from corrugated cardboard, an insulating space and a photovoltaic panel. The multi-layered composite wall has a first inwardly disposed dense, organically based panel to which is affixed a first plate made from corrugated cardboard, the flutes of the corrugated cardboard construction being disposed transversely to the panel surface; a second dense, organically based panel affixed to the aforementioned plate, to the second dense, organically based panel is affixed a second plate made from a denser corrugated cardboard, the flutes of which are disposed transversely to the panel surface, providing inertia to temperature variations; a third dense, organically based panel connected to said second plate, which third dense, organically based panel has a light absorbing layer on an outwardly disposed surface thereof; and, connected to the light absorbing layer or the third dense, organically based panel, a third plate made from corrugated cardboard the flutes of which are disposed transversly to the panel surface. The third plate has an air gap outwardly disposed thereof in which air is free to circulate by means of vents disposed at the extreme ends of the photovoltaic panel. The photovoltaic panel is made up of photovoltaic cells transparent to infrared radiation from the sun. It is structurally connected to the construction wall at a distance defining said air gap and disposed outwardly so as to gather the sun's rays when installed.

### CROSS REFERENCE TO RELATED APPLICATIONS

This application claims the benefit of U.S. Provisional Application No. 61/944,584, entitled: TRANSPARENT, PHOTOVOLTAIC, THERMALLY INSULATING, CONSTRUCTION WALL COMPRISING CORRUGATED MATERIAL filed on 26 Feb. 2014, the contents of which are incorporated by reference herein.

### COPYRIGHT & LEGAL NOTICE

A portion of the disclosure of this patent document contains material which is subject to copyright protection. The Applicant has no objection to the facsimile reproduction by anyone of the patent document or the patent disclosure as it appears in the Patent and Trademark Office patent file or records, but otherwise reserves all copyright rights whatsoever. Further, no references to third party patents or articles made herein is to be construed as an admission that the present invention is not entitled to antedate such material by virtue of prior invention.

### BACKGROUND OF THE INVENTION

This invention relates to construction walls and in particular, walls which are made up at least in part of corrugated material, and the buildings of which the walls form integral parts. Such walls are known in the art. However, they do not take advantage of the benefits of such corrugated material in storing and transferring heat, and in particular, heat transmitted through or emitted by solar panels. Neither has electricity generation in conjunction with such walls been used before.

What is needed is a construction wall having a corrugated construction and an integrated solar panel, and buildings and other structures made from these walls.

### SUMMARY OF THE INVENTION

A functionalized construction wall is provided, having an inner surface adapted to face an inner enclosed space, and an outer surface adapted to gather photovoltaic energy from the sun when installed. The construction wall includes a multi-layered composite wall comprising plates made from corrugated cardboard, an insulating space and a photovoltaic panel. The completed cardboard defines flutes which are elongated spaces running in the cardboard. The multi-layered composite wall has a first inwardly disposed dense, organically based panel to which is affixed a first plate made from corrugated cardboard, the flutes or corrugations of which are disposed transversely to the panel surface so that the flutes are oriented perpendicular to the said surface; a second dense, organically based panel affixed to the aforementioned plate, to said second dense, organically based panel is affixed a second plate made from a denser corrugated cardboard, the flutes of which are similarly disposed transversely to the panel surface, providing inertia to temperature variations; a third dense, organically based panel connected to said second plate, which third dense, organically based panel has an infrared light absorbing layer on an outwardly disposed surface thereof; and, connected to the light absorbing layer or the third dense, organically based panel, a third plate made from corrugated cardboard, the flutes of which are disposed transversely to the panel surface. The third plate has an air gap outwardly disposed thereof in which air is free to circulate by convection by means of vents disposed at the extreme ends of the photovoltaic panel. The photovoltaic panel is made up of photovoltaic cells essentially transparent to infrared radiation from the sun. It is structurally connected to the construction wall at a distance defining said air gap and disposed outwardly so as to gather the sun's rays when installed.

An object of the invention is to allow infrared radiation, e.g. long wavelength electromagnetic rays from the warm photovoltaic cells, as well as sun light transmitted through these, to heat up the infrared absorbing layer.

Another object of the invention is to allow for convection caused by such heating to help maintain a constant or more stable wall temperature when the construction wall is used to build a building.

Another object of the invention is to generate photovoltaic electricity.

Yet another object of the invention is to store photovoltaic solar energy in a battery system for use in lighting or in complementary heating.

These and other objects of the invention are further described in the drawings, detailed description, and claims.

### BRIEF DESCRIPTION OF THE DRAWINGS

FIG. 1A is a top view of a solar panel used in the invention.

FIG. 1B is a side view of a solar panel used in the invention.

FIG. 2A is a cross sectional view of the construction wall, operating with sunlight incident at a shallow angle in winter.

FIG. 2B is a cross sectional view of the construction wall of the invention, illustrating a summer operational scenario.

FIG. 3 is a perspective view of a building utilizing a photovoltaic wall of the present invention.

FIG. 4 is a perspective view of a building complex utilizing more than one buildings illustrated in FIG. 3.

FIG. 5 is a cross section view of a variant of a photovoltaic construction wall flute component of the invention.

Those skilled in the art will appreciate that elements in the Figures are illustrated for simplicity and clarity and have not necessarily been drawn to scale. For example, dimensions may be exaggerated relative to other elements to help improve understanding of the invention and its embodiments. Furthermore, when the terms ‘first’, ‘second’, and the like are used herein, their use is intended for distinguishing between similar elements and not necessarily for describing a sequential or chronological order. Moreover, relative terms like ‘front’, ‘back’, ‘top’ and ‘bottom’, and the like in the Description and/or in the claims are not necessarily used for describing exclusive relative position. Those skilled in the art will therefore understand that such terms may be interchangeable with other terms, and that the embodiments described herein are capable of operating in other orientations than those explicitly illustrated or otherwise described.

### DETAILED DESCRIPTION OF THE PREFERRED EMBODIMENT

The following description is not intended to limit the scope of the invention in any way as they are exemplary in nature, serving to describe the best mode of the invention known the inventors as of the filing date hereof. Consequently, changes may be made in the arrangement and/or function of any of the elements described in the exemplary embodiments disclosed herein without departing from the spirit and scope of the invention.

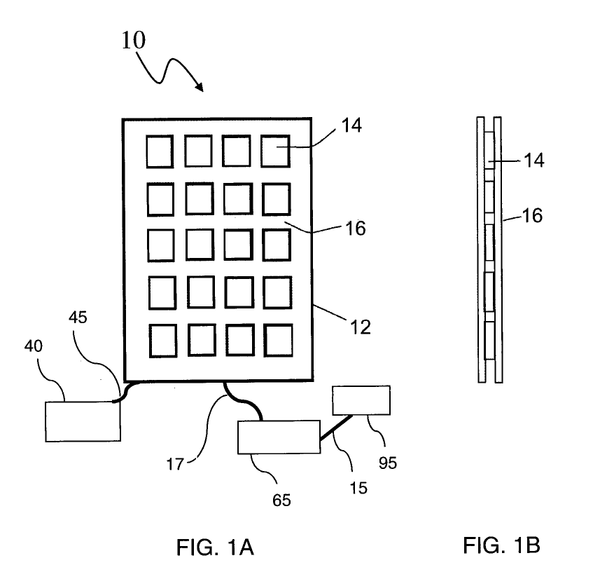

Referring now to FIGS. 1A and 1B, solar panel 10 used in the invention includes a mechanically stable frame 12, for example from polyurethane, solar glass 16, and polycrystalline or amorphous solar cells 14. Solar power by means of a power converter 65 which is connected via one or more hardwired pathways 15 to charge batteries 95 for autonomous use or connected to electrical power grid 40 via hardwired pathway 45.

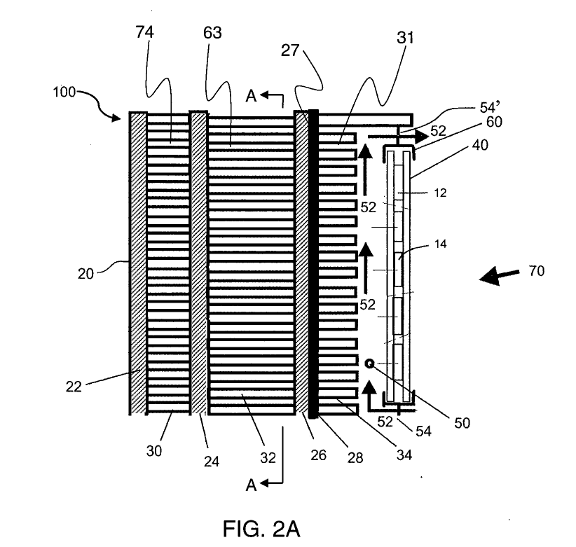

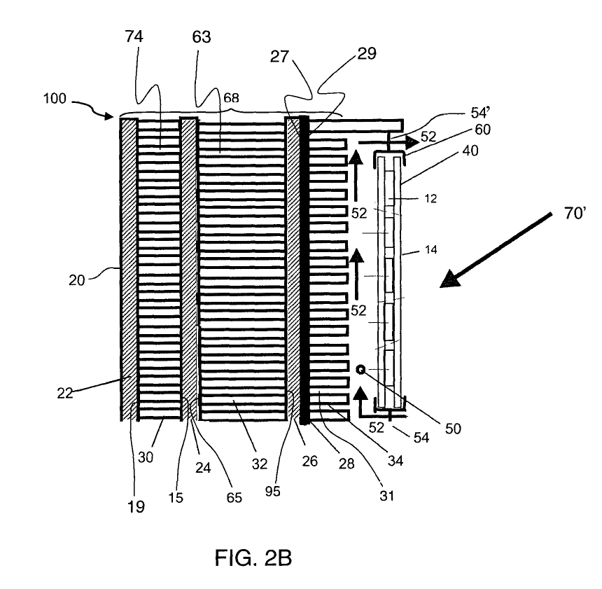

Referring now to FIG. 2A, a photovoltaic construction wall 100 uses the solar panel of FIGS. 1A and 1B. The wall 100 has an inner surface 20 adapted to face an inner enclosed space, and an outer surface 40 adapted to gather energy from the sun when installed. The construction wall includes a multi-layered composite wall comprising plates made from corrugated cardboard providing thermal insulation and inertia, an insulating air gap providing further thermal inertia and a photovoltaic panel. The corrugated cardboard construction defines elongated flutes adjacent corrugations. The multi-layered composite wall has a first inwardly disposed dense, organically based panel 22 to which is affixed a first plate 74 made from corrugated cardboard, the flutes 30 of which are disposed transversely (i.e. so that the flutes are oriented perpendicularly) to the panel surface; a second dense, organically based panel 24 affixed to the aforementioned first plate 74, to the second dense, organically based panel 24 is affixed a second plate 63 optionally made from a denser corrugated cardboard (smaller flutes 32), the flutes 32 of which are also disposed transversely (i.e. so that the flutes are oriented perpendicularly) to the panel surface, and providing inertia to temperature variations; a third dense, organically based panel 26 connected to the second plate 63, which third dense, organically based panel has an infrared light absorbing layer 28 on an outwardly disposed surface 27 thereof; and, connected to the light absorbing layer or the third dense, organically based panel 26, a third plate 31 made from corrugated cardboard, the flutes 34 of which are disposed transversely (e.g. so that flutes are oriented to the panel surface). The third plate has an air gap 50 outwardly disposed thereof in which air 52 is free to circulate by making use of natural convection by means of vents 54 at the bottom of solar panel 10 and vents 54′ at its top. Photovoltaic panel 10 is made up of photovoltaic cells 14 transparent to infrared radiation from the sun. It is structurally connected 60 to the multi-layered composite wall and disposed outwardly so as to gather the sun's rays when installed. The corrugated cardboard of first plate 74, second plate 63 and third plate 29 is preferably made waterproof and fireproof via suitable impregnation, such as that embodied in PCT Application Nos. PCT/IB2012/002173, PCT/IB2014/000332, and PCT/IB002635, the contents of which are incorporated by reference herein.

The materials from which components of the invention are constructed also include wood, artificially simulated wood and particle products, hemp, bamboo, cotton, and organically based natural materials, in one variant of the invention. In another variant of the invention, the materials in carbon based materials including derivatives of natural and synthetic minerals, e.g. oil, tar, crude, etc.

Optionally, the corrugated cardboard could be replaced with other corrugated materials. Preferably, also such structure is made waterproof and fireproof, via a supplemental treatment of the material.

As illustrated in FIG. 2A, the operation of the construction wall 100 is shown during a winter month with sun light 70 of low intensity incident at a shallow angle. During day time infrared radiation from the warm surfaces of solar cells 14 generates enough heat even in the absence of direct sun shine. It is appreciated that the walls are also mounted on pivots with mechanisms to angularly position and orient the walls at optimal angles to capture the maximum amounts of light.

Further, when there is sufficient sunshine, then electrical energy generated by solar panel 10 may be used for lighting of light sources or for supplementary heating by energizing heat sources, e.g. electrical heaters. Alternatively, surplus solar energy may be stored in a battery for use in lighting or for supplementary heating either at night or during days with overcast sky. Alternatively, when there is sufficient sunshine, surplus electrical energy generated by solar panel 10 may be fed to the electrical power grid.

Referring now to FIG. 2B, the construction wall is shown operating in the summertime. In this configuration, sun light 70′ of higher intensity is incident on the solar panel at a steeper angle. Under such intense irradiation, circulating air 52 helps in avoiding extreme warming of wall 100. The thermal inertia of plate 32 made from dense corrugated cardboard helps to limit temperature variations. Air circulation also causes less temperature variation in the wall surface at night.

The photovoltaic construction wall 100 preferably comprises plates 74, 63, 31 made from corrugated cardboard made according to a process described in WO2013/061151 A4, or U.S. Provisional Patent Application Ser. Nos. 61/833,959 and 61/911,001, the content of which are herein incorporated by reference.

As illustrated in FIG. 2B, and in a variant of the invention, the photovoltaic construction wall 100 includes a multi-layered composite wall 68. Multi-layered wall 68 includes a first inwardly disposed dense, organically based panel 20 having a major panel surface 19 to which is affixed a first composite plate 74 made from corrugated cardboard in which flutes 30 of the cardboard are disposed perpendicular to the major panel surface 19 and thereby define a major corrugated panel surface 15; and, a second dense, organically based panel 24 affixed to the major corrugated panel surface 15, to which a second plate 24 of corrugated cardboard is attached, thereby defining a second major corrugated panel surface 63 in which flutes 32 of the cardboard are disposed perpendicular to the panel surfaces 65 and 95; and, a third dense, organically based panel 26 which third dense, organically based panel has connected to a major surface 27 thereof an infrared light absorbing layer 28; and, connected to a major surface 29 of the light absorbing layer (or the third dense, organically based panel 26 in another embodiment) is a third composite plate 31 made from corrugated cardboard the flutes 34 of which are disposed transversely to (e.g. so that flutes are oriented perpenticularly to the panel surface). It is appreciated that the flutes 30, 32, and 34 are disposed substantially perpendicularly or completely perpendicularly to the various panels 20, 24, and 28, and generally glued or otherwise adhered thereto.

An object of the invention is to allow radiation, e.g. infrared rays from solar cells 14 as well as light 70, 70′ of the sun to heat up light absorbing layer 28 and with it the entire multi-layered composite wall.

Another object of the invention is to allow for convection caused by such heating to help maintain a constant or more stable wall temperature when the construction wall is used to build a building.

In another variant of the invention, the photovoltaic construction wall is made from plates made from corrugated cardboard according to a process and structurally constructed as described in WO2013/061151 A4, or U.S. provisional application Ser. Nos. 61/833,959 and 61/911,001, the contents of which are herein incorporated by reference.

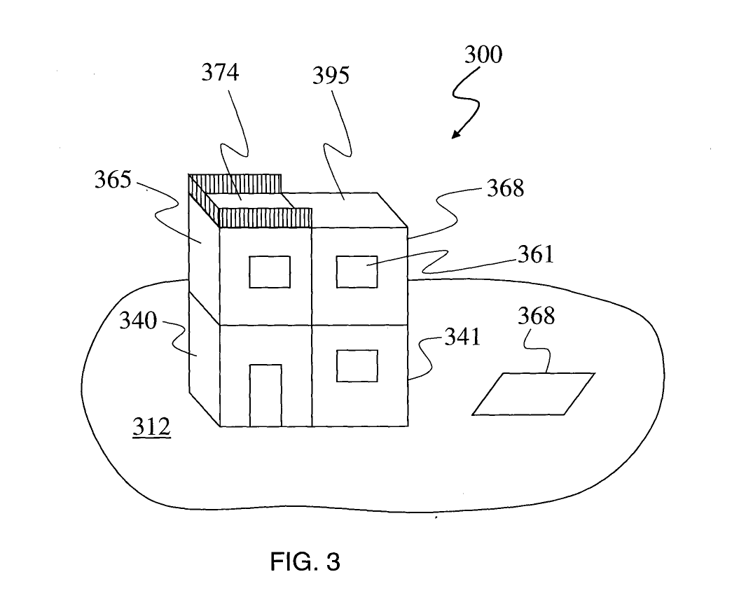

In another variant, as illustrated in FIG. 3, the invention provides a building 300. Building 300 includes at least one, and preferably, more than one (2, 3, 4 or more) photovoltaic walls 365, 395 as described above. Building 300 also includes traditional building components 361, in addition to the photovoltaic walls 365, 395, which are optionally incorporated in family homes. Exemplary traditional building components 361 include telecommunications infrastructure, fire alarm and fire quenching systems, water systems and sewerage systems, HVAC, electrical systems, computer controlled features, windows, as well as other traditional building components. In another variant, the building 300 includes multiple family dwelling habitats 368, and can also, optionally include three dimensional commercial units 340, leasehold and/or freehold habitable three dimensional units 341, and outdoor and on building 300 private and/or public spaces 374. In another variant, building 300 includes other green components 386 other than photovoltaic energy generating wall(s) 365, 395, e.g. remote solar panels and solar energy relating farms. Building 300 is fixed to a terrestrial land mass 312.

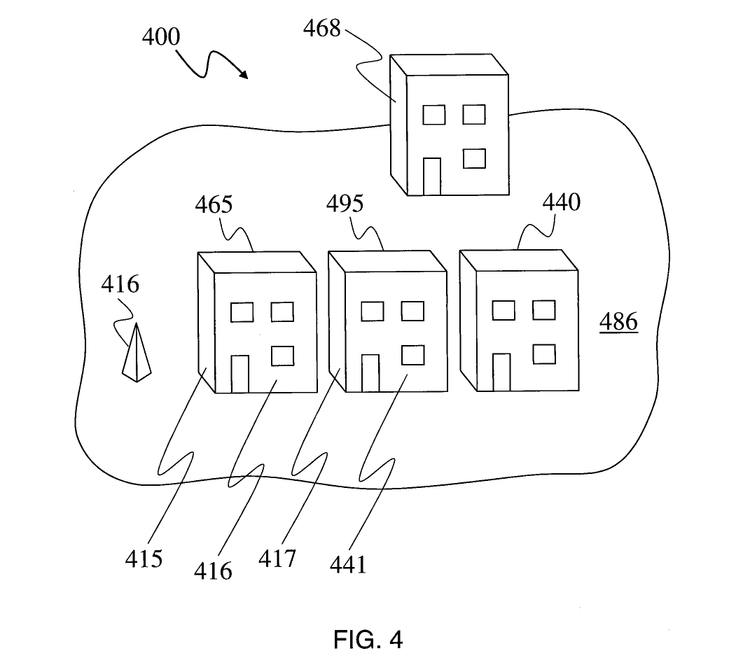

As illustrated in FIG. 4, more than one building 465, 495, 440, and 468 (of the type described in FIG. 3, alone or in combination with traditional buildings) are grouped together to form a family of buildings or building complex 400. One or more of the buildings 465, 495, 440, 468 comprise at least one and preferably more than one photovoltaic wall as described above. Building complex 400 sits upon terrestrial land mass 486 upon which building complex 400 is permanently fixed. Building complex 400 further includes one or more non-habitable structures 416, e.g. sheds, artwork, etc. The non-habitable structures 416 have also at least one photovoltaic wall as described herein. The buildings or portions of the building complex optionally include modular units, e.g. either individual apartment dwellings/units forming at least a portion of at least one building 465, 495, 440, 468 within the building complex 400, or portions of the at least one buildings 465, 495, 440, 468. Included in buildings 465, 495, 440 and 468, are one or more photovoltaic walls as described herein, including for example walls 415, 416, 417, and 441. Each of the buildings 465, 495, 440, 468 for example include one or more walls as described herein, oriented to optimize solar energy collection. Further the buildings are oriented on the land mass 486 at angles and in proper geometric orientation to optimize capture of light or solar energy to increase the efficiency of collection, and the overall optimization of solar energy collection efficiency. It is appreciated that the invention and buildings and structures described herein include one, two to . . . N number of walls described herein.

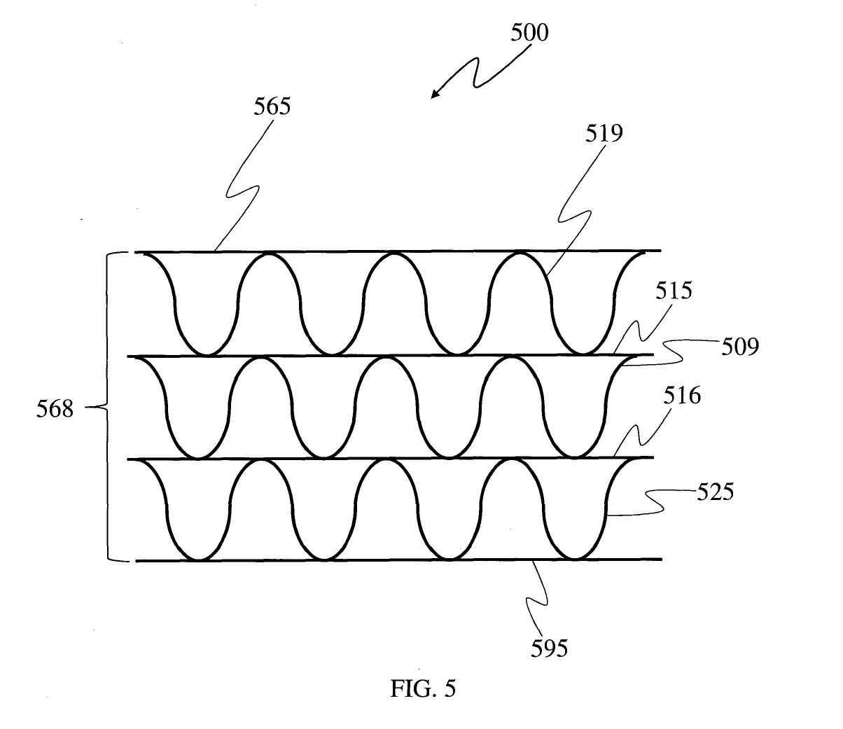

As illustrated in FIG. 5, and in a variant of the invention of FIGS. 2A and 2B, a side cross sectional view taken along plane A-A of FIG. 2A, a portion of a structurally load bearing wall 500 includes layered and adhered, photovoltaic construction wall components group 568 (e.g. the portions of wall 500 that include flutes 30, 32, and 34). A major panel of corrugated planar cardboard or other suitable organic material 565 is provided. Material 565 is joined to planar cardboard panel 515 by permanent adherence with glue at the plurality of peaks of undulating or wave shaped corrugated (indulating) cardboard or paper material 519, while the paper material 519 is permanently joined planar cardboard material 515 at a plurality points at the bottom of the waves of material 519. Planar cardboard material 516 is joined to planar cardboard material 515 with corrugated material 509 which again has a undulating shape with peaks and troughs which are joined to material 515 and 516. Likewise planar cardboard material 516 is joined to planar cardboard material 595 via paper or glued corrugated material 525, at the peaks and troughs of the material 525. The materials 519, 509, and 525 resemble waves, e.g. ocean waves or sinusoidal waves. It is appreciated that although only three layers of flutes 30, 32, and 34 are shown, many more layers typically exist in the walls of the invention in order to form a unitary, strong, load bearing construction, making up the overall wall components 74, 63, and 31. Conversely, the invention functions although less optimal, when the panel 20 and corrugated plate 74 are removed from the embodiment shown in FIG. 2A and FIG. 2B.

It is further appreciated that the invention provides a manufacturing process for making a photovoltaic construction wall having an inner surface adapted to face a inner enclosed space and an outer surface adapted to face the environment when installed. The process includes the steps of inwardly disposing a multi-layered composite wall providing thermal insulation and inertia; insulating an air gap; and, outwardly disposing a photovoltaic panel structurally connected to the construction wall and separated from the construction wall by the air gap. The process also includes: inwardly disposing a first inwardly disposed dense, organically based panel having a major panel surface to which is affixed a first plate made from corrugated cardboard in which flutes of the cardboard are disposed perpendicular to the major panel surface and thereby define a major corrugated panel surface; and, affixing a second dense, organically based panel affixed to the major corrugated panel surface, to which a second plate of corrugated cardboard is attached, thereby defining a second major corrugated panel surface in which flutes of the cardboard are disposed perpendicular to the panel surface; and, connecting a third dense, organically based panel that is connected to the second major corrugated panel surface; and, attaching a third dense, organically based panel which is attached to a third plate made from corrugated cardboard, such that the flutes of the cardboard are disposed perpendicular to the panel surface.

Examples of other green components and systems utilized in the invention, in combination, include natural energetic processes that can be harnessed with little pollution. Anaerobic digestion systems, geothermal power systems, wind power systems, small-scale hydropower systems, other solar energy systems, biomass power systems, tidal power systems, wave power systems, and systems deriving energy from the incineration of waste.

Moreover, the system contemplates the use, sale and/or distribution of any goods, services or information having similar functionality described herein.

As will be appreciated by skilled artisans, the present invention may be embodied as a system, a device, or a method.

It should be appreciated that the particular implementations shown and herein described are representative of the invention and its best mode and are not intended to limit the scope of the present invention in any way.

The specification and figures should be considered in an illustrative manner, rather than a restrictive one and all modifications described herein are intended to be included within the scope of the invention claimed. Accordingly, the scope of the invention should be determined by the appended claims (as they currently exist or as later amended or added, and their legal equivalents) rather than by merely the examples described above. Steps recited in any method or process claims, unless otherwise expressly stated, may be executed in any order and are not limited to the specific order presented in any claim. Further, the elements and/or components recited in apparatus claims may be assembled or otherwise functionally configured in a variety of permutations to produce substantially the same result as the present invention. Consequently, the invention should not be interpreted as being limited to the specific configuration recited in the claims.

Benefits, other advantages and solutions mentioned herein are not to be construed as critical, required or essential features or components of any or all the claims.

As used herein, the terms “comprises”, “comprising”, or variations thereof, are intended to refer to a non-exclusive listing of elements, such that any apparatus, process, method, article, or composition of the invention that comprises a list of elements, that does not include only those elements recited, but may also include other elements described in the instant specification. Unless otherwise explicitly stated, the use of the term “consisting” or “consisting of” or “consisting essentially of” is not intended to limit the scope of the invention to the enumerated elements named thereafter, unless otherwise indicated. Other combinations and/or modifications of the above-described elements, materials or structures used in the practice of the present invention may be varied or adapted by the skilled artisan to other designs without departing from the general principles of the invention.

The patents and articles mentioned above are hereby incorporated by reference herein, unless otherwise noted, to the extent that the same are not inconsistent with this disclosure.

Other characteristics and modes of execution of the invention are described in the appended claims.

Further, the invention should be considered as comprising all possible combinations of every feature described in the instant specification, appended claims, and/or drawing figures which may be considered new, inventive and industrially applicable.

Copyright may be owned by the Applicant(s) or their assignee and, with respect to express Licensees to third parties of the rights defined in one or more claims herein, no implied license is granted herein to use the invention as defined in the remaining claims. Further, vis-à-vis the public or third parties, no express or implied license is granted to prepare derivative works based on this patent specification, inclusive of the appendix hereto and any computer program comprised therein.

Additional features and functionality of the invention are described in the claims appended hereto. Such claims are hereby incorporated in their entirety by reference thereto in this specification and should be considered as part of the application as filed.

Multiple variations and modifications are possible in the embodiments of the invention described here. Although certain illustrative embodiments of the invention have been shown and described here, a wide range of changes, modifications, and substitutions is contemplated in the foregoing disclosure. While the above description contains many specific details, these should not be construed as limitations on the scope of the invention, but rather exemplify one or another preferred embodiment thereof. In some instances, some features of the present invention may be employed without a corresponding use of the other features. Accordingly, it is appropriate that the foregoing description be construed broadly and understood as being illustrative only, the spirit and scope of the invention being limited only by the claims which ultimately issue in this application.

1. A photovoltaic construction wall having an inner surface adapted to face a inner enclosed space and an outer surface adapted to face the environment when installed, the construction wall comprising:
a. an inwardly disposed multi-layered composite wall providing thermal insulation and inertia;
b. an insulating air gap; and
c. an outwardly disposed photovoltaic panel structurally connected to the construction wall and separated from the construction wall by the air gap.

2. The photovoltaic construction wall of claim 1, wherein said multi-layered composite wall comprises:
a. an optional first inwardly disposed dense, organically based panel having a major panel surface to which is affixed an optional first plate made from corrugated cardboard in which flutes of the cardboard are disposed perpendicular to the major panel surface and thereby define a major corrugated panel surface; and
b. a second dense, organically based panel affixed, when optional panel are used, to the major corrugated panel surface, to which a second plate of corrugated cardboard is attached, thereby defining a second major corrugated panel surface in which flutes of the cardboard are disposed perpendicular to the panel surface; and
c. at least a third dense, organically based panel connected to the second major corrugated panel surface, to which at least third dense, organically based panel is attached an at least third plate made from corrugated cardboard in which flutes of the cardboard are disposed perpendicular to the panel surface.

3. The photovoltaic construction wall of claim 1, wherein vents are provided at extreme ends of the photovoltaic panel to permit air to circulate by convection.

4. The photovoltaic construction wall of claim 2, wherein said third dense, organically based panel has an infrared light absorbing layer on an outwardly disposed surface thereof.

5. The photovoltaic construction wall of claim 2, wherein said second plate is made from denser corrugated cardboard to provide inertia to temperature variations.

6. The photovoltaic construction wall of claim 2, wherein said plates made from corrugated cardboard, the cardboard being made according to a process of manufacturing a cardboard building construction material, the cardboard building construction material comprising a plurality of glued cardboard plies, wherein, the cardboard plies are rolled on a drum into a roll and wherein glue is circumferentially applied in spaced apart radial strips thereby defining a non-glued region between the strips, and wherein a cutter cuts the cardboard plies from an outer diameter toward an inner diameter of the roll, thus avoiding fouling of the cutter with glue and permitting simultaneous cutting of the roll as the roll is formed.

7. The photovoltaic construction wall of claim 1, wherein electrical energy generated by said solar panel is used in at least one of a number of modes, the modes selected from the group consisting of a feed into an electrical power grid, a storage in a battery, and a supplementary heating system.

8. A building, the building comprising: at least one photovoltaic wall according to claim 1.

9. The building of claim 8 further comprising: traditional building components in addition to said more than one photovoltaic wall.

10. (canceled)

11. (canceled)

12. The building of claim 9 further comprising: leasehold and/or freehold habitable units.

13. The building of claim 9 further comprising: private and/or public spaces.

14. The building of claim 9 further comprising: green components other than said more than one photovoltaic wall.

15. The building of claim 9 further comprising: a terrestrial land mass for fixing said building thereon.

16. A building complex, the building complex comprising: a plurality of buildings, at least one of the buildings including one or more photovoltaic walls according to claim 1.

17. The building complex of claim 16, further comprising: a terrestrial land mass upon which said building complex is permanently fixed.

18. The building complex of claim 17, further comprising non-habitable structures, the non-habitable structures comprising at least one photovoltaic wall according to claim 1.

19. The building complex of claim 16, further comprising modular units forming at least a portion of at least one building within the building complex.

20. The building complex of claim 9 further comprising one or more public use buildings.

21. A process of constructing a photovoltaic construction wall having an inner surface adapted to face a inner enclosed space and an outer surface adapted to face the environment when installed, the process comprising:
a. inwardly disposing a multi-layered composite wall providing thermal insulation and inertia; and,
b. outwardly disposing a photovoltaic panel structurally connected to the construction wall and separated from the construction wall by the air gap, thereby creating a sufficient air gap.

22. A process of constructing a photovoltaic construction wall, the photovoltaic construction wall includes a multi-layered composite wall, the process including the steps of:
a. inwardly disposing a dense, organically based panel having a major panel surface;
b. affixing thereto a first composite plate made from corrugated cardboard in which flutes of the cardboard are disposed perpendicular to the major panel surface, thereby defining a major corrugated panel surface;
c. affixing a second dense, organically based panel to the major corrugated panel surface;
d. attaching a second plate of corrugated cardboard thereto, thereby defining a second major corrugated panel surface in which flutes of the cardboard are disposed perpendicular to the panel surfaces and;
e. connecting an infrared light absorbing layer to a major surface of a third dense, organically based panel; and
f. connecting to a major surface of the light absorbing layer (or the third dense, organically based panel in another embodiment) a third composite plate made from corrugated cardboard the flutes of which are disposed transversely to the major surface.
